(19) United States
(12) Patent Application Publication
(10) Pub. No.: US 2025/0319840 A1
(43) Pub. Date: Oct. 16, 2025

(54) CRASH-TESTED SINGLE POINT AUTOMOTIVE RESTRAINING DEVICE WITH HIGH STRENGTH SWIVEL CARABINER

(71) Applicant: Nick Smart, Tampa, FL (US)

(72) Inventor: Nick Smart, Tampa, FL (US)

(21) Appl. No.: 19/249,142

(22) Filed: Jun. 25, 2025

Related U.S. Application Data
(63) Continuation-in-part of application No. 18/797,885, filed on Aug. 8, 2024.
(63) Continuation-in-part of application No. 18/105,149, filed on Feb. 2, 2023, now abandoned.
(60) Provisional application No. 63/305,709, filed on Feb. 2, 2022.

(51) Int. Cl. B60R 22/10; A01K 27/00; B60R 22/18; B60R 22/34

(52) U.S. Cl. CPC B60R 22/10; A01K 27/004; B60R 22/18; B60R 22/34; B60R 2022/1806; B60R 2022/1812

(57) ABSTRACT

A crash-tested single point restraining device comprising a housing having a tensioning and retracting mechanism which is mechanically coupled to a reel assembly secured within the housing, a proximal end having a standard seat belt insert member and/or an anchoring point connecting element, an extendable and retractable seat belt webbing anchored within the housing having a high strength swiveling carabiner at a distal end, a stitched area formed near said distal end of the retractable seat belt webbing, and a retraction limiting component integrated on the seat belt webbing between the housing and the stitching to prevent damage to the stitching. In one embodiment, the housing is affixed permanently to an interior location of a vehicle. In another embodiment, the high-strength swiveling carabiner is composed of 7075 aluminum alloy.

### CROSS-REFERENCE TO RELATED APPLICATIONS

This application is a continuation-in-part application of U.S. patent application Ser. No. 18/797,885, filed Aug. 8, 2024, which is a continuation-in-part application of U.S. patent application Ser. No. 18/105,149, filed Feb. 2, 2023 which claims priority from U.S. Provisional Application 63/305,709 filed on Feb. 2, 2022.

### FIELD OF INVENTION

The present invention relates to a single point restraining device having a retraction limiting component for safely restraining a pet within a vehicle that can be removably connected to an existing anchoring point within a vehicle or can be permanently affixed to the interior of a vehicle. More specifically, the crash-tested single point restraining device utilizes a carabiner having an integrated swivel mechanism, thereby eliminating tangles and twists in the connected strap.

### BACKGROUND OF THE INVENTION

Safety belt restrainers, car seats, and other devices have been improved in recent years as crash data clearly indicate that some restraint is necessary even for small children and pets. Small children, and pets in particular, are difficult to restrain because of their small size. An additional problem encountered with pets is that they are not shaped like humans and the restraining device of the safety belt restrainer must be modified to conform to the size and shape of the pet to be restrained.

However, the proper and safe restraint of a pet in a vehicle presents several challenges. For instance, finding an easily securable attachment for a pet leash can be difficult. All newer automobiles are provided with safety restraints which are designed to accommodate humans, they are not suitable for restraining pets because of the differences in body size and shape. In addition, if a leash attachment point is found within a vehicle, inevitably there will be a certain amount of slack in the leash to provide the pet with a humane amount of mobility. Further, in the event of an accident or abrupt stop, this slack can result in the pet being projected forwarded and then suddenly jerked to a stop when the slack in the leash has run out, which can lead to serious injury of the pet in any hard braking scenario or impact event.

A carabiner clip can be used to removably secure a pet restraining device to a pet harness, pet collar, or other pet article of clothing. In some instances, the carabiner clip is a swiveling carabiner. However, finding a suitable swiveling carabiner with adequate strength and compact size in nearly impossible. Light-duty swiveling carabiner clips have been integrated into pet leashes. These swiveling carabiner clips are small and simple to use, but lack the strength to withstand a significant force, such as a hard braking scenario or impact event. Typically, these light-duty swiveling carabiners are composed of inexpensive alloys or even plastic composites and as a result, they fail catastrophically under high stress situations. Such light-duty swiveling carabiners simply are not constructed for critical applications.

Heavy-duty swivel carabiners have been developed for climbing and industrial use. These heavy-duty swivel carabiners are designed to handle massive forces, but they are oversized, bulky, and impractical for applications such as pet restraining devices which require portability and flexibility. In addition, climbing carabiners typically do not include swivels because climbers prefer fixed, non-rotating connections to maintain stability.

In September 2024, a swiveling carabiner composed from 7075 aluminum, a high-strength alloy was introduced. The term “7075” refers to the specific aluminum alloy composition. The swiveling feature allows for 360-degree rotation and has a quick-attach mechanism for rapid and secure connections, making it ideal for use as in certain applications requiring strength and durability, including as a connector for pet leashes.

### PRIOR ART

Attempts have been made in the prior art to develop pet restraint devices, either multi-point harness devices, or belts or straps connected in some manner to an existing vehicular seat belt system. Some of such devices have tensioning and retracting systems that inherently manage slack in a retractable webbing when the pet moves closer to the anchoring point of the device. Of course, when there is slack, the pet is not restrained during an impact event.

Another problem that occurs with belts used in vehicles for restraining pets is that the end of the belt or webbing strap attached to the pet collar typically is looped back on itself to prevent the hook from retracting back into the housing. Thus, such belts are using the thickness of the double back and stitching as an attempt to stop the retracting. This looped back portion then will bang against the tensioner and over time, this repeated action will rip up the edge of the sewn-downed stitching. This repeated banging and sliding action can be exacerbated greatly by a pet which creates abrasion of the stitching and can cause the stitching to become frayed. The result of such fraying is that the belt can be compromised over time and no longer provide a proper or sufficient degree of restraining force.

An additional and significant concern with many vehicle restraining belts for pets is that they are not crash-tested. Quite simply, these types of vehicle restraining belts for pets are not built or designed to provide adequate protection during a car accident. For a restraining belt to be crash-test worthy, it must meet certain industry standards. Currently, the industry standard is the “pulse sled test” which simulates a 30 mph accident into a dead stop. This test is the same test as used by the FMVSS 213 Child Restraint code for test vehicle seat belts for humans, particularly children. Many pet restraining belts claim that they are “safety belts” for pets. However, unless such prior art pet restraining belts have undergone crash-testing using industry standards, they cannot be deemed as pet safety belts during impact events as they have not demonstrated that they meet the industry standards of being crash-tested safety restraining belts for pets. Rather, they simply are pet restraining devices.

U.S. Patent Application Publication 2016/0227732 A1 to Pompey provides a pet harness device having a latching member pivotally connected to a rewindable leash housing, the latching member being configured to be received into and latched within a seat belt receiver. Pompey also provides a secondary pivotable attachment clip to an attachment point other than the seat belt. Pompey does not provide for a retraction limiting component to prevent damage to the leash belt or webbing. In U.S. Patent Application Publication 2021-0170985 A1 to Anderson, a self-tension and retracting belt device is disclosed which is capable of being connected to a conventional seat belt receiver. However, like Pompey, Anderson does not provide any retraction limiting component. Further, there is no indication that either Pompey or Anderson are crash-tested safety belts. Rather, they appear to be vehicle restraining devices for pets. Accordingly, there remains a need for a single point restraining device for restraining a pet within a vehicle that is capable of safely securing a pet within the vehicle and which has a retraction limiting component to prevent damage to the leash webbing. Such a restraining device should also have important safety features including anti-twisting of the leash webbing, a tear away feature of the webbing to provide some additional extension under force and should be crash-tested worthy. Further, such a restraining device should have multiple attachment means.

Despite the attempts of the prior art, a need still exists for a crash-tested single point automotive restraining device utilizing a high-strength swivel carabiner as a harness connector. More particularly, the high-strength swiveling carabiner should be of sufficient size and weight the it delivers both rotational freedom to the pet but one that also is crash-tested and capable of withstanding high-impact events.

### SUMMARY OF THE INVENTION

The invention of the present subject matter relates to a crash-tested single point restraining device for pets which can be removably connected to a conventional vehicle safety belt system, to an existing anchoring point within a vehicle or can be permanently affixed to the interior of a vehicle.

Accordingly, it is an object of the present subject matter to provide a single point restraining device for pets which can be used with a conventional three-point vehicle seat belt system.

It is another object of the present subject matter to provide a single point restraining device for pets which is removably connected to a standard seat belt receiver.

It is yet another object of the present subject matter to provide a single point restraining device for pets which can be removably secured to an anchoring point within a vehicle, such as an anchor point utilized in conjunction with infant seats.

It is still another object of the present subject matter to provide a single point restraining device for pets which can be permanently affixed to the interior of a vehicle and be removably connected to a pet harness or pet collar.

It is a further object of the present subject matter to provide a single point restraining device for pets having a retraction limiting component to prevent the stitching near the pet harness connecting end from being retracted into the housing of the restraining device.

It is yet a further object of the present subject matter to provide a single point restraining device for pets having a retraction limiting component which prevents damage such as fraying or abrasion of the stitching.

It is an additional object of the present subject matter to provide an improved single point restraining device for pets having a tear away feature.

It is another object of the present subject matter to provide an improved single point restraining device having a high-strength swivel carabiner as the pet harness connecting end.

It is yet another object of the present subject matter to provide an improved single point restraining device having a high-strength swivel carabiner composed of 7075 aluminum alloy.

These and other objects of the present subject matter are accomplished by providing a single point restraining device comprising a housing having a tensioning and retracting mechanism which is mechanically coupled to a reel assembly secured within the housing, a first end having a standard seat belt insert member and/or an anchoring point connecting element, an extendable and retractable seat belt webbing anchored within the housing having a high-strength swiveling carabiner composed of 7075 aluminum alloy at a second end which is distal from the first end, a stitched area formed by looping a length of the seat belt webbing over a looping bar and connecting adaptor near the distal end, and a retraction limiting component disposed on the belt between the housing and the stitched area to prevent damage to the stitching. In an alternate embodiment, the housing is affixed permanently to an interior location of a human passenger vehicle, such as an automobile, SUV, RV, bus, train, water vessel, or an airplane.

### BRIEF DESCRIPTION OF DRAWINGS

FIG. 1 is an environmental view of the single point restraining device of the present subject matter.

FIG. 2 is a plan view of a first embodiment of the single point restraining device of the present subject matter depicting two attachment means, a standard male seat belt connector and an Isofix hook connector.

FIG. 3 is a plan view of an embodiment of the retraction limited component of the single point restraining device of the present subject matter.

FIG. 4 is a plan view of another embodiment of the retraction limited component of the single point restraining device of the present subject matter.

FIG. 5 is a plan view of an embodiment of the single point restraining device of the present subject matter depicting an Isofix hook connecting element.

FIG. 6 is a perspective view of a car seat illustrating anchoring points for engaging the anchoring point connector of the single point restraining device of the present subject matter.

FIG. 7 is a side view of a car seat illustrating anchoring points within an interior of a vehicle for engaging the anchoring point connector of the single point restraining device of the present subject matter.

FIG. 8 is a perspective view of an anti-twist component for use with the single point restraining device of the present subject matter.

FIG. 9 is a perspective view of a tear-away component for use with the single point restraining device of the present subject matter.

FIG. 10 is a perspective view of another embodiment of the single point restraining device of the present subject matter illustrating the device permanently affixed to an interior part of a human passenger vehicle.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “single point restraining device”, “restraining device, “safety device for restraining a pet”, “automotive restraining belt”, “safety harness” and similar terms may be used throughout the specification and it is to be understood that such terms are interchangeable and all refer to the single point restraining device of the present subject matter. Further, the terms “vehicle”, “human passenger vehicle”, and “passenger vehicle” may be used throughout the specification and it is to be understood that such terms are interchangeable and all refer to a vehicle which is capable of transporting people and pets. In addition, the terms “swivel” and “swiveling” are used throughout the specification and are interchangeable.

As described herein, the term “removably secured”, “removably attached”, “removably connected”, and derivatives thereof shall be used to describe a situation wherein two or more objects are connected in a non-permanent manner to allow the same objects to be repeatedly connected and separated.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

Further, it is to be understood that the terms “belt”, “strap”, “retractable belt”, “belt webbing”, “webbing”, “safety belt”, “seat belt webbing”, and “retractable seat belt webbing”, derivatives and variations thereof as used throughout the specification are interchangeable and all refer to the retractable seat belt webbing of the present subject matter. In addition, it is to be understood that the terms “pet harness”, “pet collar”, “pet clothing”, derivatives and variations thereof as used throughout the specification are interchangeable and all refer to an article worn by a pet to which the single point restraining device of the present subject matter can be removably connected.

The present subject matter is directed to a crash-tested single point restraining device for safely harnessing and restraining a pet within a vehicle. The restraining device comprises a housing having a tensioning and retracting mechanism which is mechanically coupled to a reel assembly secured within the housing, a first end having a standard seat belt insert member and/or an anchoring point connecting element, an extendable and retractable seat belt webbing anchored within the housing having a high strength swivel carabiner at a second end which is distal from the first end, a stitched area formed by looping a length of the seat belt webbing and sewing it upon itself near the distal end having the high strength swivel carabiner, and a retraction limiting component integrated on the belt between the housing and the stitching to prevent damage to the stitching.

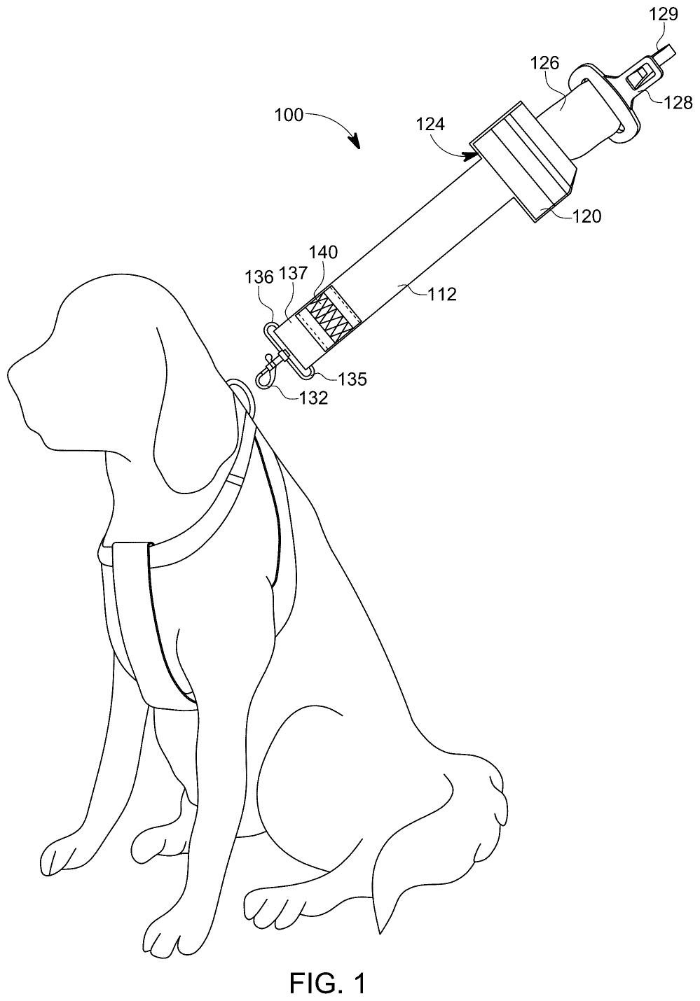

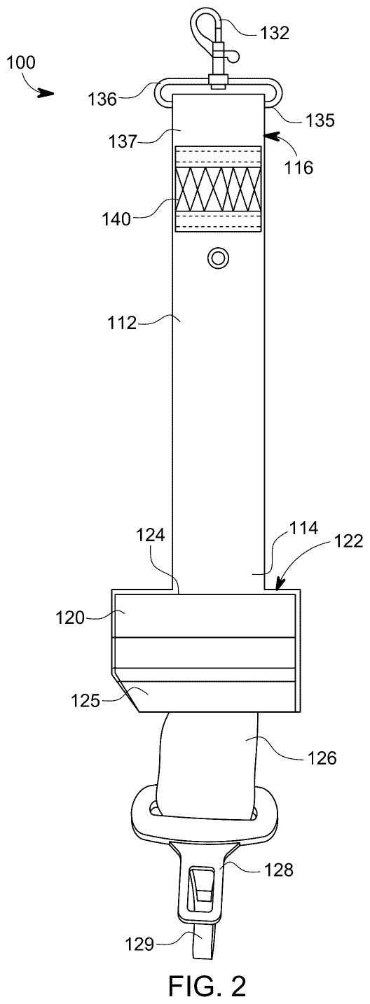

Referring now to FIG. 1 and FIG. 2, the single point restraining device 100 of comprises a housing 120 having a tensioning and retracting mechanism which is mechanically coupled to a reel assembly secured within the housing. The tensioner component of the tensioning and retracting mechanism may use a centrifugal clutch or pendulum lock mechanism while the retractor component may use a spring retractor mechanism, but any mechanism familiar to those of skill in the art may be used here. The self-tensioning mechanism may be, for example, a centrifugal clutch mechanism or a pendulum lock mechanism.

The retractor component may be configured to apply a force to wind the retractable seat belt webbing 112 on the reel and this force may be adjusted to be stronger or weaker depending on the strength of the pet. Adjustment mechanisms of this type are well known to those of skill in the art and can take many forms. Alternately, the device 100 may have a tensioning force commensurate with the size of the pet so that, for example, a large dog still can move freely but will be held back with sufficient force to discourage excessive movement, this force being determined by trial and error during the manufacturing process. The tensioner may be configured to lock the reel to fix an extended length of the retractable seat belt webbing 112 and may be configured to pretension and lock the reel in response to a trigger, such as a sudden movement or an impact event

The single point restraining device further comprises a retractable seat belt webbing 112 having a proximal end 114 and a distal end 116, the proximal end 114 being attached or anchored to the reel assembly contained within housing 120. The retractable seat belt webbing 112 preferably is made of a non-elastic woven material, such as polyester. Inelastic materials including, but not limited to, polyester or nylon seat belt webbing are examples of suitable materials for the retractable seat belt webbing of the present subject matter.

The housing 120 further includes an opening 124 which is a slotted opening sufficiently sized for the retractable seat belt webbing 112 to pass through with minimal clearance, thereby allowing a length of the retractable seat belt webbing 112 to be selectively extended from the housing 120 in any manner which will be obvious to those skilled in the art. The tension and retracting mechanism operably functions to control extension and retraction of the retractable seat belt webbing 112.

At the distal end of the retractable seat belt webbing 112, a short length of the webbing is inserted under a looping bar 135 of collar adaptor 136 and then sewn back onto itself thereby creating a loop 137 and securing the seat belt webbing 112 to the collar adapter 136. The looping bar 135, the collar adaptor 136 and the loop 137, together cooperate to prevent the seat belt webbing 112 from retracting completely into the housing 120. Affixed to the collar adapter 136 is a high strength swivel carabiner 132. The high strength swivel carabiner 132 is configured for attachment to a pet harness, pet collar, or other article of pet clothing having a connecting means. The high strength swivel carabiner 132 is composed of a 7075 aluminum alloy which is characterized by exceptional strength. 7075 aluminum alloy primarily is composed of aluminum, with zinc being the key alloying element, along with magnesium, copper, and chromium. This 7075 aluminum alloy offers high strength-to-weight ratio, good fatigue resistance, and reasonable machinability. Preferably, the high-strength swivel carabiner crafted from 7075 aluminum alloy is a swiveling wire gate carabiner, designed to withstand heavy loads and dynamic stress, and to endure high-impact forces without comprising its integrity. The use of the high-strength 7075 aluminum alloy as the swiveling wire gate carabiner ensures superior tensile strength, rivaling that of steel while maintaining a lightweight feel for everyday use as a harness connector.

The high-strength swiveling carabiner composed of 7075 aluminum alloy has an integrated swivel mechanism which enables 360° rotation. This type of rotation eliminates tangles and twists of a webbing strap used as the harness component of the single point automotive restraining device of the present subject matter. The smooth rotation of this carabiner is essential in dynamic environments where mobility and flexibility are of paramount concern. The swivel mechanism is machined to precise tolerances, ensuring smooth, friction-free rotation without comprising its high strength.

In a preferred embodiment, the high-strength swiveling carabiner of the present subject matter has a wire gate design, the opening providing quick and effortless attachment while reducing the risk of accidental disengagement. The wire gate's spring tension is calibrated to maintain a secure closure, thereby preventing accidental or unintentional opening during movement by the pet. The wire gate design also reduces overall weight while maintaining the structural integrity required for demanding applications, including high-impact events.

Unlike conventional swivel carabiners which can fail under stress, the high-strength swiveling carabiner utilized as the harness connector in the crash-tested single point automotive restraining device of the present subject matter has undergone rigorous crash-testing to meet or exceed industry safety standards. It is designed specifically to handle the forces associated with sudden stops and high-impact scenarios, thus providing peace of mind to the pet owner. The high-strength swiveling carabiner is anodized for corrosion resistance, making it suitable for use in wet conditions and outdoor environments. The anodizing process not only protects the metal, but also provides a sleek, professional finish that is scratch-resistant and wear-resistant.

The retractor component of the tensioning and retracting mechanism is spring-loaded in such a manner to apply a constant force to wind the retractable seat belt webbing 112 on the reel to eliminate slack and provide some restraining force on the load (e.g. pet), and the tensioner component may lock the reel to fix an extended length of the belt webbing 112 upon sudden movement to secure the load. The housing 120 comprising the tensioning and retracting mechanism and reel may comprise any suitable rigid material as is well known in the art, including but not limited to hard plastic composites, metal, or plastic-metal composites.

It should be noted that the length of the restraining belt 112 should not be more than about three feet (3′) as any length greater will permit the pet to wander and/or move to an adjacent seating area within the vehicle. If there is unlimited length, in any type of sudden stop or accident scenario, too much play or slack in the restraining belt 112 prevents effective restraint.

The area of the seat belt webbing 112 which is sewn over to form the loop 137 is referred to as stitched area 140. Stitched area 140 can be subjected to wear and tear as it passes through the slotted opening 134 when being retracted onto and extending from the reel assembly, as this stitched area is the thickest portion of retractable seat belt webbing 112 due to the overlap. This is a very common problem with active pets causing many instances of retraction and extension which leads to a fraying of the stitching 140. Ultimately, this abrasive action can weaken the stitched area 140 and reduce the effective restraining power of the retractable seat belt webbing 112 as the frayed area can fail. This potential to fail may not be apparent to the user and thus needs to be obviated.

Referring now to FIGS. 1 to 4, various embodiments of the single point restraining device constructed in accordance with the present subject matter are shown. The restraining device can permit a dog or other pet to move freely within a vehicle while also securing the dog or other pet safely in the event of a collision or other rapid change in acceleration. FIG. 1 shows the restraining device positioned for use on a pet dog wearing a harness. But the device easily can be attached to a collar or other article of pet clothing. More particularly, both a seat belt insert member 128 and an anchoring point connector 129 are joined to the rear side of the housing. This arrangement provides the user with the option of selecting a standard seat belt receiver or any of the several anchoring points to safely removably secure the pet within the vehicle. Accordingly, it will be obvious that since there are multiple anchoring points in a vehicle, the user has many options for attaching the single point restraining device of the present subject matter.

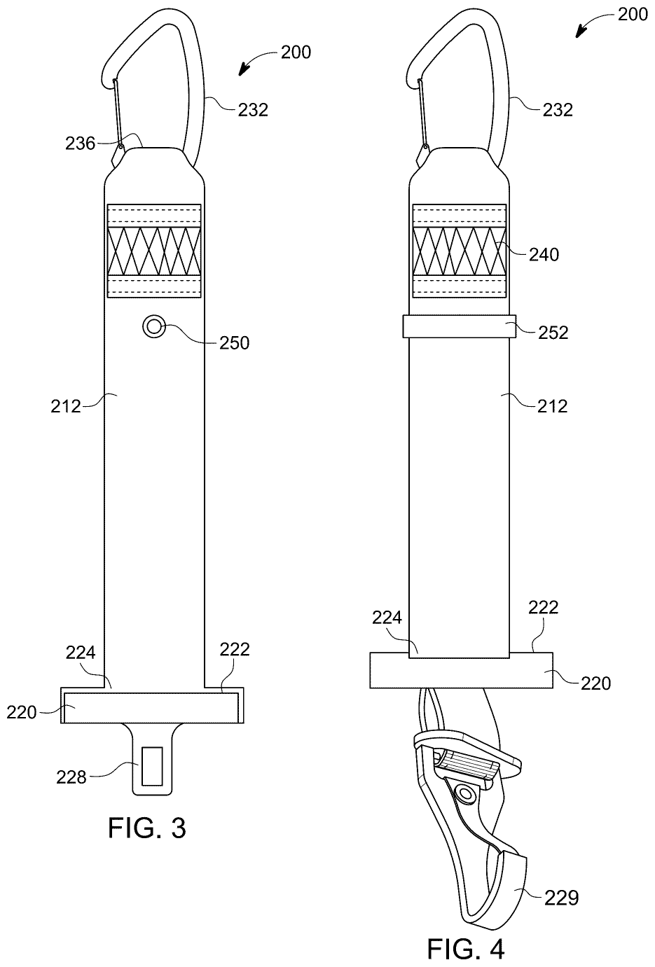

Two embodiments of the retraction limiting component of the present subject matter are shown in FIG. 3 and FIG. 4. Referring to FIG. 3, a single point restraining device 200 is shown having a housing 220, a retractable seat belt webbing 212 having a proximal end 222, and a retraction limiting component 250 integrated within the webbing, which is in the form of a button which is raised or sufficiently thick to prevent the stitching 240 of the seat belt webbing 212 from sliding into the housing 220. Specifically, the button 250 must be of sufficient size that it is too large to fit through the slotted opening 224.

Referring now to FIG. 4, the single point restraining device 200 is shown comprising a housing 200 and a retraction limiting component 252 which is in the form of an elongated rectangular shape such as a bar element having sufficient dimension to prevent retraction of the stitching 240 to pass through the slotted opening 224. In both embodiments, the retraction limiting component is securely affixed to the seat belt webbing 212 by any suitable means for securing the button 250 or bar 252, including, but not limited to fasteners and adhesives. It will be obvious to those skilled in the art that the retraction limiting component of the present subject matter can be implemented with any seat belt assembly having a retractable belt.

Also shown in FIG. 3 and FIG. 4 is an alternate embodiment to the single point restraining device of present subject matter wherein the looping bar element is replaced with a webbing material looped about the collar adapter 236 which connects to the high-strength swiveling carabiner 232.

The single point restraining device of the present subject matter further comprises means for removably securing the restraining device to a conventional vehicular seat belt assembly having a seat belt receiving element. In one embodiment, a seat belt insert member 128 is secured to the housing 120 on the rear side 125 of the housing 120. In the embodiment shown in FIG. 2, the seat belt insert member 128 is secured to and extends from a projection 126 which is connected to the rear side 125 of the housing 120 or preferably may be manufactured as part of the housing 120 as shown in FIG. 3.

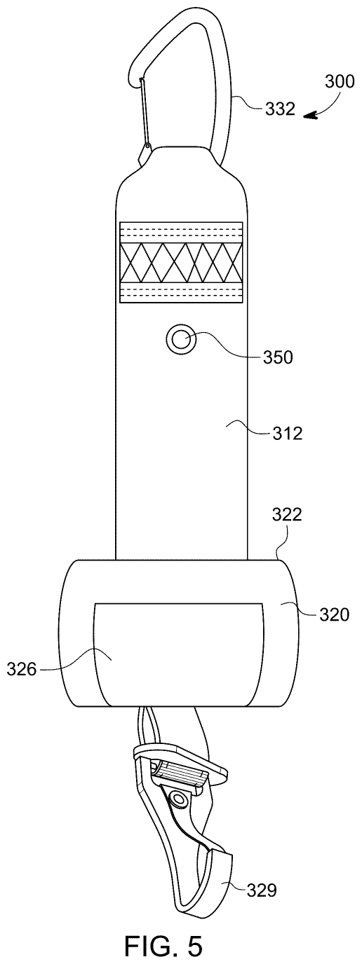

The single point restraining device of the present invention further may comprise an anchoring point connector which is capable of being removably secured to an anchoring point located in a human passenger vehicle. It is to be understood that the term “human passenger vehicle” refers to any vehicle used for human transport, including, but not limited to, an automobile, SUV, RV, bus, train, water vessel, or an airplane. Referring now to FIG. 5, the single point restraining device 300 comprises a housing 320, a retractable seat belt webbing 312, a high-strength swiveling carabiner 313, a retracting limiting component 350 and further comprises anchoring point connector 329 rather than the seat belt insert member 228 shown in FIG. 3. The anchoring point connector 329 is secured to the rear side 325 of housing in much the same manner as the seat belt insert member is secured to housing 120 or housing 220. The anchoring point connector 329 can be in the form of a hook, carabiner clip or any other suitable releasable connectors as will be obvious to those skilled in the art.

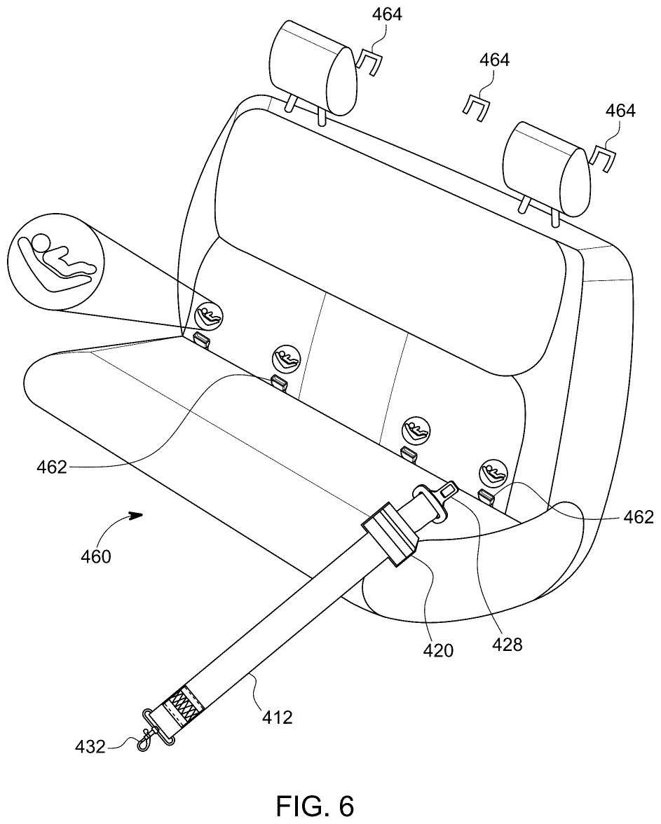

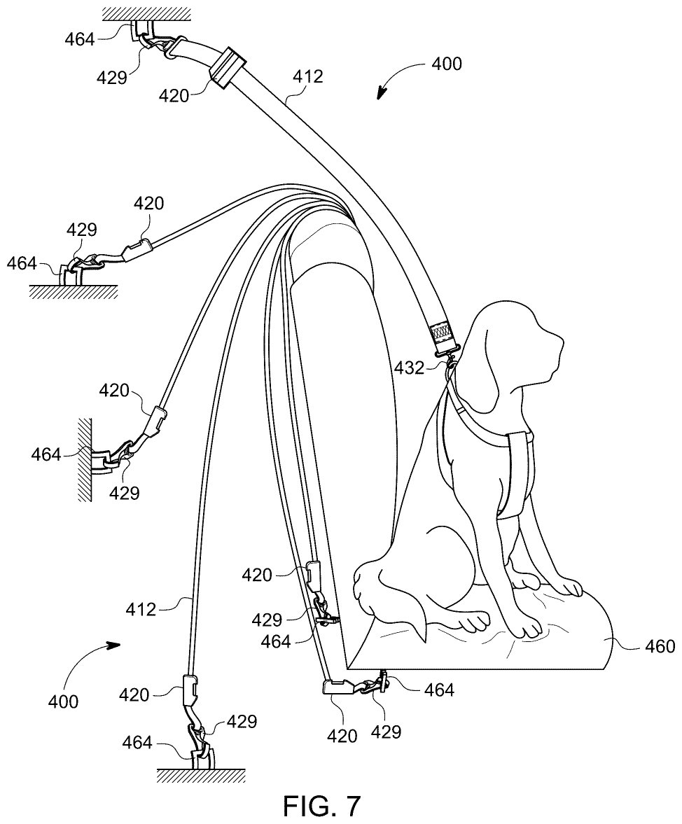

Most late model automobiles, SUVs and other recreational vehicles are provided with anchoring points which may be in the form of lower anchor points and tether anchor points. Most commonly, baby car seats and toddler car seats can be secured to a vehicle seat using one or more lower anchor points. Referring now to FIG. 6 and FIG. 7, multiple anchoring points are illustrated such as lower anchor points 462 which are embedded in a vehicle seat 460 between the backrest and lower seat cushion, and tether anchor points 464 which are located at various positions in a vehicle the rear side of a back rest, the ceiling or frame adjacent the rear door, the rear shelf of sedans, the back wall of pick-up trucks, the lower rear area of reinforced seats and the cargo floor of station wagons, hatchbacks, vans and SUV's. Accordingly, it will be obvious that since there are multiple anchoring points in a vehicle, the user has many options for attaching the crash-tested single point restraining device of the present subject matter.

In operation, a user will select a desired anchoring point and simply connect the anchoring point connector 429 of the restraining device 400 to the desired anchoring point 462 or 464. The user then can connect the high-strength swivel carabiner 432 to the pet harness or pet collar being worn by the pet in the vehicle as illustrated in FIG. 7. The pet then may move around within the vehicle and the retractable seat belt webbing 412 may be unwound or extended from the housing 420 as needed. As the pet moves closer to the housing 420, the retracting mechanism of the restraining device may shorten the exposed length of the belt 412. In the event of a sudden or rapid deceleration of the vehicle, the self-tensioning mechanism may activate to prevent the pet from being thrown forward in the vehicle.

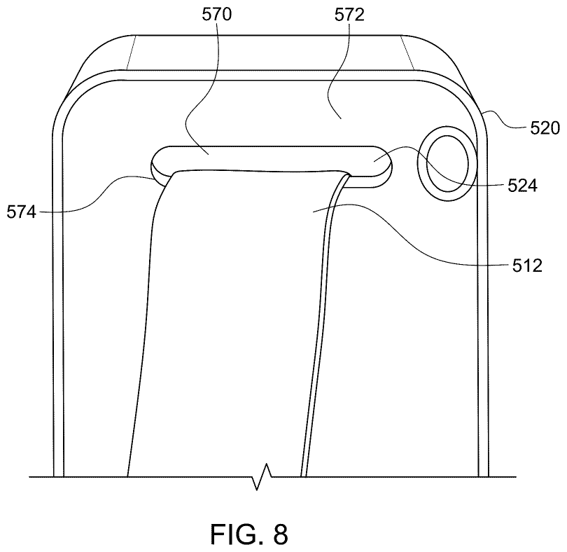

Referring to FIG. 8, an anti-twist component is depicted for use with the single point restraining device of the present subject matter. The anti-twist component is to prevent the retractable seat belt webbing from twisting upon itself while it is being extended from or retracted into the housing. The anti-twist is in the form of a metal bar 570 which spans the slot opening 524 of the housing 520. Housing 520 is depicted from the inside to illustrate the feeding of the seat belt webbing 512. As is well known, the seat belt webbing 512 passes through the slot opening 524 as it is extended and retracted. The belt can become twisted when being extended or retracted as there is sufficient space for the belt to fold over itself while within the slot or opening 524. A twisted belt is hazardous and may not function properly in an impact event. The metal bar 570 is disposed approximately halfway between the top edge 572 and the bottom edge of the slot or opening 524. The anti-twist bar component 570 reduces the vertical height of the opening to the point that the belt 512 cannot twist or fold over itself.

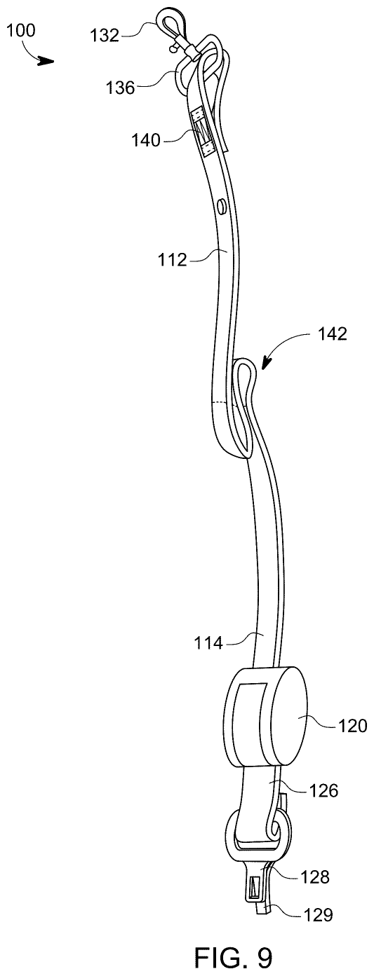

While the crash-tested single point restraining device of the present subject matter allows a user to safely restrain a pet in a vehicle, it can be appreciated that with any restraint there is a possibility of the restrained pet choking or otherwise being injured because of the position of the pet relative to the restraint at the moment of an impact event. Accordingly, the stitching of the loop can be designed with a tear away feature as illustrated in FIG. 9. This feature will cause the webbing to rupture at the stitching area when a predetermined amount of force is applied. The amount of force can be variable; for instance, the stitched area may be designed to tear more easily for small pets with a much greater force required for larger pets. It also should be understood that the belt does not tear completely, it tears partially to essentially lengthen the deceleration time to reduce the restraining force applied to the pet. As will be readily apparent to those skilled in the art, there are many methods for creating a tear away portion for the belt webbing, such as connecting the stitched area to the rest of the belt by a tear away stitching 442 as shown in FIG. 9, the tear away stitching having a predetermined tear force.

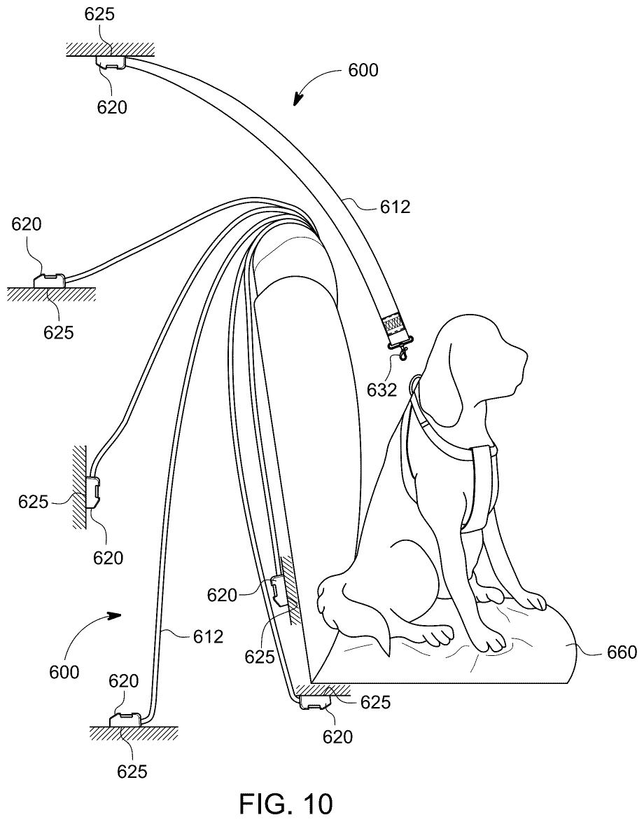

In another embodiment of the present invention, the crash-tested single point attachment device of the present subject matter is mounted or permanently affixed directly to an interior portion of any human passenger vehicle, such as the ceiling or frame, a rear shelf, a back wall, the rear of a vehicle seat or on the cargo floor. Referring now to FIG. 10, the rear side 625 of housing 620 is permanently affixed to one of more positions within a vehicle. The rear side of the housing can be permanently affixed by any means as will be obvious to those skilled in the art, including for example, welding or bolting means. In this manner, the single point attachment device 600 is part of the vehicle. In operation, the user places his pet onto seat 660 and extends the retractable seat belt webbing 612 towards the pet. The user then removably secures the pet to the restraining device 600 by attaching the high-strength swivel carabiner 632 to the pet harness.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A crash-tested single point restraining device for harnessing a pet within a human passenger vehicle having a conventional seat belt receiver, comprising:
a. a housing having a tensioning and retracting mechanism which is mechanically coupled to a reel assembly secured within the housing, a slotted opening on a front side of said housing and a rear side;
b. a seat belt insert member secured to said rear side of said housing, said seat belt insert member adapted to be removably connected to the seat belt receiver;
c. an extendable retractable seat belt webbing having a proximal end anchored within said housing through said slotted opening, and a distal end having a high-strength swivel carabiner secured thereto;
d. a stitched area formed near said distal end of said retractable seat belt webbing, said stitched area being formed by looping a length of said retractable seat belt webbing about a looping bar and collar adaptor and sewing the looped end upon itself, and
e. a retraction limiting component integrated on said retractable seat belt webbing, said retraction limiting component configured to prevent said stitched area from passing through said slotted opening.

2. The crash-tested single point restraining device for harnessing a pet within a human passenger vehicle in accordance with claim 1, wherein said high-strength swiveling carabiner is composed of 7075 aluminum alloy.

3. The crash-tested single point restraining device for harnessing a pet within a human passenger vehicle in accordance with claim 1, wherein said high-strength swiveling carabiner has an integrated swivel mechanism enabling friction-free 360° rotation.

4. The crash-tested single point restraining device for harnessing a pet within a human passenger vehicle in accordance with claim 1, wherein said high-strength swiveling carabiner has a wire gate opening providing quick and effortless attachment of said high-strength swiveling carabiner to a pet harness.

5. The crash-tested single point restraining device for harnessing a pet within a human passenger vehicle in accordance with claim 1, wherein said high-strength swiveling carabiner meets and exceeds crash-testing industry safety standards, and is designed to handle forces associates with sudden stops and high-impact events.

6. The crash-tested single point restraining device for harnessing a pet within a human passenger vehicle in accordance with claim 1, wherein said high-strength swiveling carabiner is anodized for corrosion resistance, thereby enabling it suitable for use in wet conditions and outdoor environments.

7. A crash-tested single point restraining device for harnessing a pet within a human passenger vehicle having at least one interior anchoring point, comprising:
a. a housing having a tensioning and retracting mechanism which is mechanically coupled to a reel assembly secured within the housing, a slotted opening on a front side of said housing and a rear side;
b. an anchoring point connector secured to said rear side of said housing, said anchoring point connector adapted to be removably secured to an anchoring point located within a vehicle;
c. an extendable retractable seat belt webbing having a proximal end anchored within said housing through said slotted opening, and a distal end having a high-strength swiveling carabiner secured thereto;
d. a stitched area formed near said distal end of said retractable seat belt webbing, said stitched area being formed by looping a length of said retractable seat belt webbing about a looping bar and collar adaptor and sewing the looped end upon itself, and
e. a retraction limiting component integrated on said retractable seat belt webbing, said retraction limiting component configured to prevent said stitched area from passing through said slotted opening.

8. The crash-tested single point restraining device for harnessing a pet within a human passenger vehicle in accordance with claim 7, wherein said anchoring point connector is adapted to be removably connected to lower anchor points and to tether anchor points located within the interior of a vehicle.

9. The crash-tested single point restraining device for harnessing a pet within a human passenger vehicle in accordance with claim 7, wherein said high-strength swiveling carabiner is composed of 7075 aluminum alloy.

10. The crash-tested single point restraining device for harnessing a pet within a human passenger vehicle in accordance with claim 7, wherein said high-strength swiveling carabiner has an integrated swivel mechanism enabling friction-free 360° rotation.

11. The crash-tested single point restraining device for harnessing a pet within a human passenger vehicle in accordance with claim 7, wherein said high-strength swiveling carabiner has a wire gate opening providing quick and effortless attachment of said high-strength swiveling carabiner to a pet harness.

12. The crash-tested single point restraining device for harnessing a pet within a human passenger vehicle in accordance with claim 7, wherein said high-strength swiveling carabiner meets and exceeds crash-testing industry safety standards, and is designed to handle forces associates with sudden stops and high-impact events.

13. The crash-tested single point restraining device for harnessing a pet within a human passenger vehicle in accordance with claim 7, wherein said high-strength swiveling carabiner is anodized for corrosion resistance, thereby enabling it suitable for use in wet conditions and outdoor environments.

14. A crash-tested single point restraining device for harnessing a pet within a human passenger vehicle having at least one interior anchoring position, comprising:
a. a housing having a tensioning and retracting mechanism which is mechanically coupled to a reel assembly secured within the housing, a slotted opening on a front side of said housing and a rear side;
b. an extendable retractable seat belt webbing having a proximal end anchored within said housing through said slotted opening, and a distal end having a high-strength swiveling carabiner secured thereto;
c. a stitched area formed near said distal end of said retractable seat belt webbing, said stitched area being formed by looping a length of said retractable seat belt webbing about a looping bar and collar adaptor and sewing the looped end upon itself, and
d. a retraction limiting component integrated on said retractable seat belt webbing, said retraction limiting component configured to prevent said stitched area from passing through said slotted opening,
wherein said rear side of said housing is permanently affixed to said at least one interior anchor position.

15. The crash-tested single point restraining device for harnessing a pet within a human passenger vehicle in accordance with claim 14, wherein said high-strength swiveling carabiner is composed of 7075 aluminum alloy.

16. The crash-tested single point restraining device for harnessing a pet within a human passenger vehicle in accordance with claim 14, wherein said high-strength swiveling carabiner has an integrated swivel mechanism enabling friction-free 360° rotation.

17. The crash-tested single point restraining device for harnessing a pet within a human passenger vehicle in accordance with claim 14, wherein said high-strength swiveling carabiner has a wire gate opening providing quick and effortless attachment of said high-strength swiveling carabiner to a pet harness.

18. The crash-tested single point restraining device for harnessing a pet within a human passenger vehicle in accordance with claim 14, wherein said high-strength swiveling carabiner meets and exceeds crash-testing industry safety standards, and is designed to handle forces associates with sudden stops and high-impact events.

19. The crash-tested single point restraining device for harnessing a pet within a human passenger vehicle in accordance with claim 14, wherein said high-strength swiveling carabiner is anodized for corrosion resistance, thereby enabling it suitable for use in wet conditions and outdoor environments.
